(19) United States
(12) Patent Application Publication
(10) Pub. No.: US 2016/0353459 A1
(43) Pub. Date: Dec. 1, 2016

(54) APPARATUS AND METHOD FOR ALLOCATING BASE STATION RESOURCES BASED ON VIRTUALIZATION

(71) Applicant: Electronics and Telecommunications Research Institute, Daejeon (KR)

(72) Inventor: Sun Sim CHUN, Daejeon-si (KR)

(21) Appl. No.: 15/013,202

(22) Filed: Feb. 2, 2016

(30) Foreign Application Priority Data
May 26, 2015 (KR) 10-2015-0073194

(51) Int. Cl. H04W 72/08; H04W 72/12

(52) U.S. Cl. CPC H04W 72/087; H04W 72/1236

(57) ABSTRACT

An apparatus for allocating base station resources based on virtualization. The apparatus includes a virtual scheduling part configured to comprise virtual schedulers each of which is operated for each of mobile virtual network operators (MVNOs) and performs virtual scheduling based on characteristics of a mobile service provided by each of the MVNOs, and to request resource allocation according to a virtual scheduling result; a physical scheduling part configured to comprise a channel scheduler and a quality of service (QoS) scheduler and allocate physical resources using either the channel scheduler or the QoS scheduler according to the virtual scheduling result, in response to the request for resource allocation from the virtual scheduler; and a control agent configured to interface between the virtual scheduling part and the physical scheduling part.

### CROSS-REFERENCE TO RELATED APPLICATION(S)

This application claims priority from Korean Patent Application No. 10-2015-0073194, filed on May 26, 2015, in the Korean Intellectual Property Office, the disclosure of which is incorporated herein by reference in its entirety.

### BACKGROUND

1. Field

The following description relates to resource allocation in a mobile communication system, and more particularly, to an apparatus and method for allocating base station resources to allow communication service providers to provide differentiated services to specific terminals.

2. Description of Related Art

In an existing cellular system, a macro cell operates quality of service (QoS) schedulers for each base station in order to provide scheduling which enables services to be equally offered to all user terminals.

The QoS schedulers regard a queue state of each terminal, a wireless channel environment, a delay time of each service, a minimum data rate, and the like as important parameters for scheduling, in which one common scheduler is used in one base station.

In the current trend of communication technology, macro cells and small calls are simultaneously established to allocate resources equally to all terminals, as well as provide differentiated services to particular terminals. To select such particular terminals, new criteria that are different from those used for the existing scheduling scheme may be required, and also a base station scheduling architecture that allows service providers to select the existing common scheduling scheme in order to apply different criteria for selecting terminals is required.

A service-provider-oriented scheduling scheme is needed to allow different service providers to select terminals based on their own requirements. However, unlike the existing network operators that operate networks, service-oriented operators have difficulties in directly operating the existing schedulers and physical schedulers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description relates to an apparatus and method for allocating base station resources, which allow different service providers to select terminals according to their special requirements and perform scheduling.

In one general aspect, there is provided an apparatus for allocating base station resources based on virtualization, the apparatus including: a virtual scheduling part configured to comprise virtual schedulers each of which is operated for each of mobile virtual network operators (MVNOs) and performs virtual scheduling based on characteristics of a mobile service provided by each of the MVNOs, and to request resource allocation according to a virtual scheduling result; a physical scheduling part configured to comprise a channel scheduler and a quality of service (QoS) scheduler and allocate physical resources using either the channel scheduler or the QoS scheduler according to the virtual scheduling result, in response to the request for resource allocation from the virtual scheduler, wherein the channel scheduler allocates the resources by changing a position of a frequency domain suitable for a wireless channel environment of each terminal and the QoS scheduler allocates the resources by modifying the virtual scheduling result, based on a wireless channel state, in a physical space; and a control agent configured to interface between the virtual scheduling part and the physical scheduling part.

In another general aspect, there is provided a method for allocating base station resources based on virtualization, the method including: virtually scheduling based on characteristics of a mobile service provided by each of mobile virtual network operators (MVNOs); and physically allocating the resources by changing a position of a frequency domain suitable for a wireless channel environment of each terminal or physically allocating the resources by modifying a virtual scheduling result in a physical space by taking into consideration a wireless channel state of each terminal, according to a virtual scheduling result.

Other features and aspects will be apparent from the following detailed description, the drawings, and the claims.

### BRIEF DESCRIPTION OF THE DRAWINGS

FIG. 1 is a diagram illustrating an apparatus for allocating base station resources based on virtualization according to an exemplary embodiment.

FIG. 2 is a diagram illustrating channel scheduling according to an exemplary embodiment.

FIG. 3 is a diagram for explaining quality of service (QoS) scheduling according to an exemplary embodiment.

FIGS. 4A to 4C are diagrams illustrating examples of a virtual machine for scheduling according to an exemplary embodiment.

FIG. 5 is a signal flowchart for explaining a method for allocating base station resources based on virtualization according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

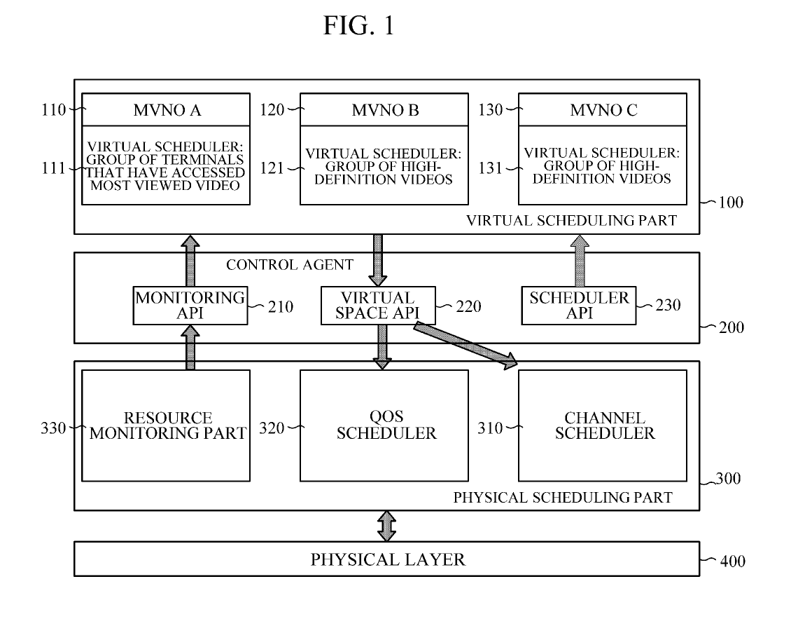

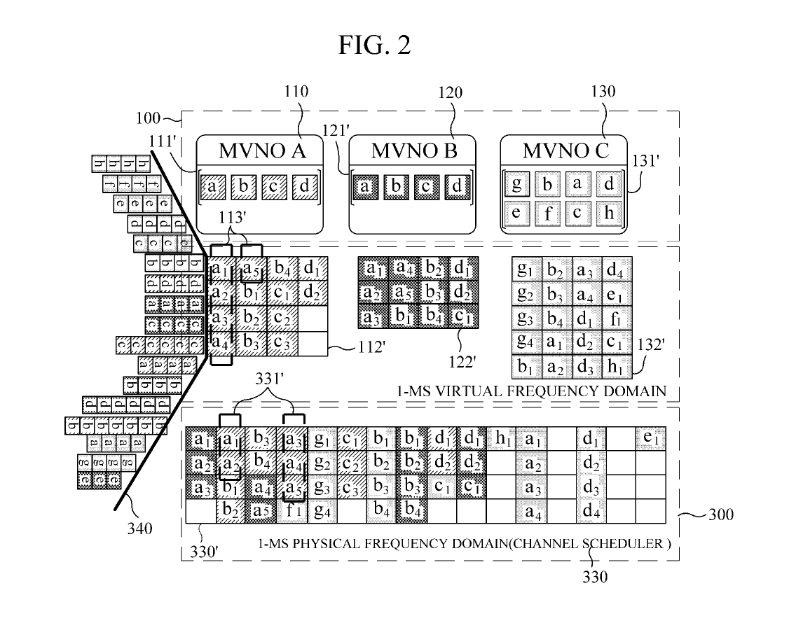

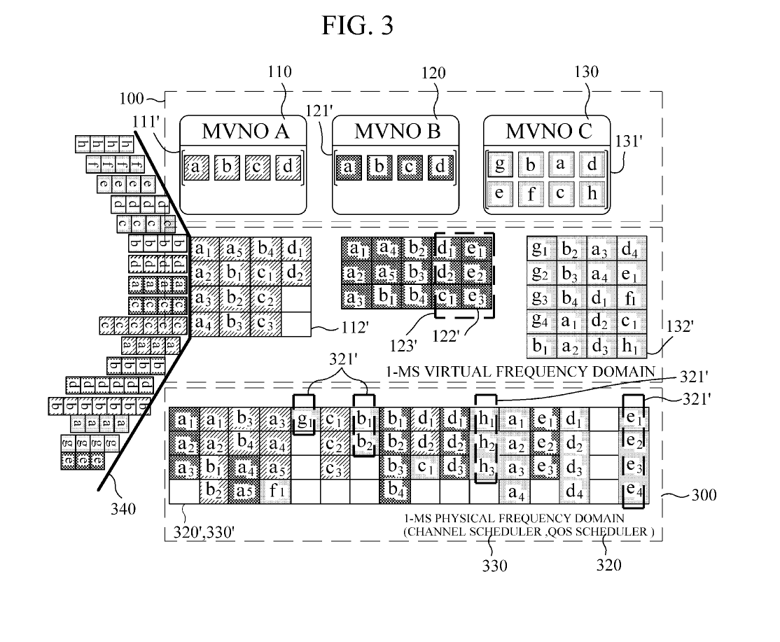

FIG. 1 is a diagram illustrating an apparatus for allocating base station resources based on virtualization according to an exemplary embodiment; FIG. 2 is a diagram illustrating channel scheduling according to an exemplary embodiment; and FIG. 3 is a diagram for explaining quality of service (QoS) scheduling according to an exemplary embodiment.

Referring to FIG. 1, an apparatus for allocating base station resources based on virtualization includes a virtual scheduling part 110 and a physical scheduling part 300 to perform scheduling in a divided manner. The virtual scheduling part 110 and the physical scheduling part 300 are interfaced with each other by a control agent 200. The reason for separating the virtual scheduling part 100 and the physical scheduling part 300 is to reduce both complexity of schedulers and the overhead required for transmitting wireless channel control information, as well as to allow for simultaneous virtual scheduling and physical scheduling, wherein the virtual scheduling is for satisfying characteristics of each service and the physical scheduling is for efficiently using resources.

The control agent 200 processes information provided by the physical scheduling part 300, provides the processed information to the virtual scheduling part 100, also processes information provided by the virtual scheduling part 100 and provides the processed information to the physical scheduling part 300. The control agent 200 allows any service providers to easily access a system and operate a variety of physical schedulers, thereby facilitating the recognition of any additional schedulers.

The virtual scheduling part 100 performs scheduling according to priorities based on mobile service characteristics, and issues request for resource allocation according to the scheduling result. Conventionally, to provide services equally to all user terminals, parameters of each terminal, such as a queue state, a wireless channel environment, delay time for each service, and a minimum data rate, were taken into consideration in scheduling. However, the virtual scheduling part 100 does not provide equal service to terminals, but rather provides independent scheduling according to priorities based on mobile service characteristics.

A mobile virtual network operator (MVNO) or a service provider, which offers media or web services, may provide a mobile service. Each of MVNOs 110, 120, and 130 reserves the time for use resources and an amount of resources to use per unit time from mobile network operators (MNOs). If the MNO takes a reservation for resources, it indicates that the MNO has enough resources to meet the reservation, and hence the MNO should ensure the reserved amount of resources to be allocated to the MVNO.

The virtual scheduling part 100 includes virtual schedulers 111, 121, and 131 which are operated by MVNO A 110, MVNO B 120, and MVNO C 130, respectively. Each of the virtual schedulers 111, 121, and 131 selects one or more terminals according to priorities based on service characteristics, and transmits scheduling virtualization information to the physical scheduling part 300 through the control agent 200, wherein the scheduling information specifies an amount of virtual frequency allocated to each of the selected terminal.

Referring to FIG. 1, if MVNO A 110, which is a service provider that offers videos online, wants to provide a differentiated service regarding “video a” that is the most viewed recently, MVNO A 110 supports a simple virtual scheduler 111 that arranges terminals which have selected “video a” in the order of subscription. MVNO A 110 performs virtual scheduling that reflects characteristics of MVNO A's service, selects and groups (111′ in FIG. 2) terminals that have subscribed to “video a,” and transmits to the control agent 300 information specifying an amount of virtual frequency allocated to each terminal

Referring to FIG. 2, MVNO A 110 allocates five virtual frequency domains 113′ to terminal a, which is currently the earliest subscriber, four virtual frequency domains 112′ to terminal b, three virtual frequency domains 112′ to terminal c, and two virtual frequency domains 112′ to terminal d. Each MVNO 110, 120, and 130 determines how to allocate the virtual frequency domains to each terminal.

Here, sets of 1-ms virtual frequency domains 112′, 122′, and 132′ in FIG. 2 each indicates an amount of frequency domain resources reserved by each MVNO. In addition, each MVNO does not directly allocate packets from a queue of each terminal to the 1-ms virtual frequency domains, but allocates frequency domain resources in a virtual space as if it allocated packets.

Referring back to FIG. 1, MVNO B 120, which is a service provider that provides a CDN service, gives priorities to terminals that have subscribed to high-definition streaming, then drives a virtual scheduler 121, and transmits a group 121′ of selected terminals to the control agent 200.

MVNO C 130, which runs an online shopping business, gives a higher priority to terminals that have a higher past purchase payment amount, and transmits a group 131′ of terminals of higher priorities to the control agent 200. As such, the MVNOs configure the differentiated virtual scheduling part 100 based on their own service characteristics, independently of each other. Each MVNO performs scheduling and resource allocation with respect to the reserved frequency domains in a virtual space at their reserved time, independently of each other. Information about MVNO's scheduling is transmitted to the physical scheduling part 300 via a virtual space application program interface (API) 220 in the control agent 200.

The physical scheduling part 300 is operated by the MNOs, and allocates resources to each MVNO according to the virtual scheduling, in response to a request allocation request from the virtual scheduling part 100. As described above, the virtual scheduling part 100 focuses on securing the independency of resource allocation, whereas the physical scheduling part 300 performs scheduling with focus on resource sharing in order to increase resource efficiency.

According to the exemplary embodiment, the physical scheduling part 300 includes a channel scheduler 310 and a quality of service (QoS) scheduler 320.

According to the received scheduling virtualization information, the channel scheduler 310 allocates the resources by changing positions of frequency domains suitable for the wireless channel environment of each terminal. This is to take into account the variability of a wireless frequency environment. For example, referring to FIG. 2, packets a1 to a5 113′ of terminal a are allocated in physical frequency domains 331′ that are apart from each other. That is, although the channel scheduler 310 allocates the same amount of wireless resources as the virtual scheduler, allocation locations of each wireless resource are differed. The channel scheduler 310 allocates the already secured amount of wireless resources to each MVNO, and hence the resource allocation of each MVNO is not affected by an event, such as joining of a new terminal, movement of terminals or drastic changes in a channel environment. The channel scheduling has an advantage that each terminal can be allocated as much amount of wireless resources as each MVNO wants.

The QoS scheduler 320 allocates the resources by modifying the scheduling virtualization information in a physical space based on the wireless channel state. The wireless channel state of each terminal is variable, and thus a condition that requires the consideration of the wireless channel state in terms of resource efficiency may arise. For example, referring to FIG. 3, MVNO C 130 changes a physical scheduling scheme and changes the amount of resources allocated to terminals g, e, b, and h 321′, while MVNO B deletes terminal c, newly allocates terminal e 123′, as well as allocates a newly reserved amount of wireless resources 122′ to terminal e.

Also, in the process of allocation of resources by modifying the scheduling virtualization information based on a wireless channel state, the QoS scheduler 320 may provide two or more QoS scheduling algorithms in the form of a module, wherein the QoS scheduling algorithms are differently applicable in a virtual scheduling space. The QoS scheduling algorithms may include proportional fair (PF), modified largest weighted delay first (M-LWDF) and distributed minimum-distortion scheduling (DMDS) algorithms. Specifically, each of the MVNOs 110, 120, and 130 selects in advance one of the QoS scheduling algorithms, and then the physical scheduling part 300 is operated based on the previously selected QoS scheduling algorithm when the channel scheduler 310 is changed to the QoS scheduler 320.

To change the physical scheduling scheme, a scheduler API 230 in the control agent 200 suggests an efficient scheduler suitable for a current channel environment. In addition, the virtual space API 220 sends scheduling information of each MVNO to either the channel scheduler 310 or the QoS scheduler 320 depending on which is selected.

The scheduler API 230 monitors the wireless channel state of each terminal, and when Condition 1 and Condition 2 as specified below are satisfied in the course of channel scheduling, the scheduler API 230 suggests the change of physical scheduling scheme.

<Condition 1>

The number of terminals forcibly terminated>alpha 1

<Condition 2>

QoS scheduling bit rate—channel scheduling bit rate>alpha 2

The scheduler API 230 calculates the bit number by changing the order of terminals in the group provided by each MVNO and the amount of resources allocated to each terminal such that a QoS scheduling scheme can be satisfied. Then, when Condition 2 is satisfied, the scheduler API 230 sends a notification of the change of physical scheduling scheme to relevant MVNOs 110, 120, and 130. However, a decision on the change of physical scheduling scheme is made by the corresponding MVNOs 110, 120, and 130.

According to an exemplary embodiment, the physical scheduling scheme, as well as the virtual scheduling scheme, may be differently applied to each MVNO. In order to provide a differentiated service only to the terminals selected by each MVNO, a physical scheduler selected by each of the MVNOs is executed for each of said MVNOs. For example, referring to FIG. 3, MVNO A and MVNO B are applied a channel scheduling scheme 320′ and 330′ and MVNO C is applied a QoS scheduling scheme 320′ and 330′. According to the exemplary embodiment, the order in which the physical schedulers are executed follows the sequence of the MVNOs which are arranged in an ascending order based on the amount of wireless resources used.

In addition, the physical scheduler 300 includes a resource monitoring part 330 that configures wireless channel information of each user terminal and transmits the wireless channel information to the control agent 200. The virtual scheduling part 100 performs virtual scheduling according to the wireless channel information transmitted through the control agent 200. Here, the wireless channel information may include at least one of the following information: currently reserved wireless resources, wireless resources currently used on average, and a state of packet queue of each terminal.

In specific, the monitoring API 210 of the control agent 200 receives state information about the packet queue of each terminal from the resource monitoring part 330. The monitoring API 210 forwards various information of each terminal, such as wireless channel information, queue information, and utilization of reserved resources, to the virtual scheduling part 100.

In addition, the monitoring API 210 creates an admission control list for terminals that do not meet the lowest MCS level, and transmits said list to each MVNO. Each MVNO makes a decision on the admission control.

Further, the monitoring part 330 forwards the information about currently reserved wireless resources and information about the wireless resources currently used on average to the monitoring API 210. The API 210 instructs each of the MVNOs 110, 120, and 130 that it is required to increase or reduce the amount of reserved resources. Each of the MVNOs 110, 120, and 130 determines whether to increase or reduce the amount of reserved resources based on the received information.

In the system as described above, each of the MVNOs 110, 120, and 130 may configure a virtual machine for scheduling. In order to enable a service provider-oriented scheduling function, each service provider directly chooses a scheduler out of a plurality of physical schedulers. That is, the service providers may be allowed to configure a base station scheduling virtual machine by choosing desired functions.

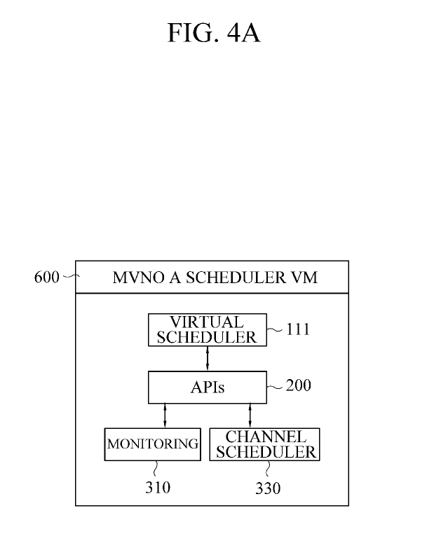

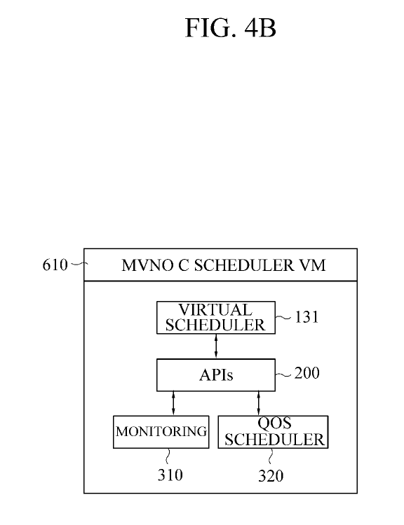

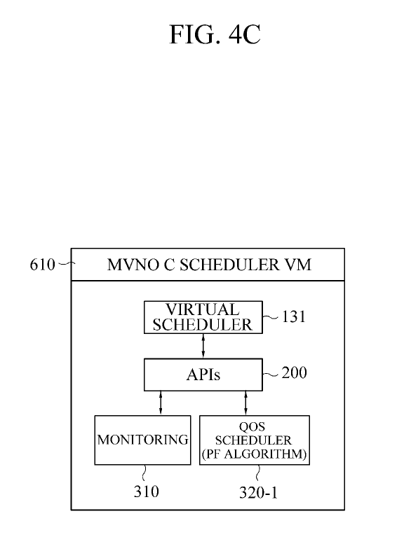

FIGS. 4A to 4C are diagrams illustrating examples of a virtual machine for scheduling according to an exemplary embodiment.

Referring to FIG. 4A, MVNO A configures a scheduler virtual machine 600 that includes virtual scheduler A 111 and a channel scheduler 330. Referring to FIG. 4B, MVNO C configures a scheduler virtual machine 610 that includes virtual scheduler C 131 and a channel scheduler 320. According to the exemplary embodiment, a channel scheduler 320 in FIG. 4B may specify a PF algorithm that is a QoS scheduling algorithm selected by MVNO C, as shown in FIG. 4C.

Thus, any service providers can advantageously select a scheduler based on characteristics of their services by implementing functions, which are required for scheduling, in virtual form.

As such, the virtual scheduling part 100 provides resource isolation, by which resources are allocated to each service provider without being affected by joining of new terminals, moving of terminals, or drastic changes in a channel environment. Also, the virtual scheduling part 100 is configured to virtualize any functions required for scheduling based on a general interface and allow any service providers (or network operators) to perform scheduling based on characteristics of their services, thereby providing operator customization. In addition, the virtual scheduling part 100 may increase resource efficiency by offering a scheduling scheme that can reduce the complexity of the scheduler even if said scheduling scheme is a physical scheduler changing scheme and suboptimal scheme.

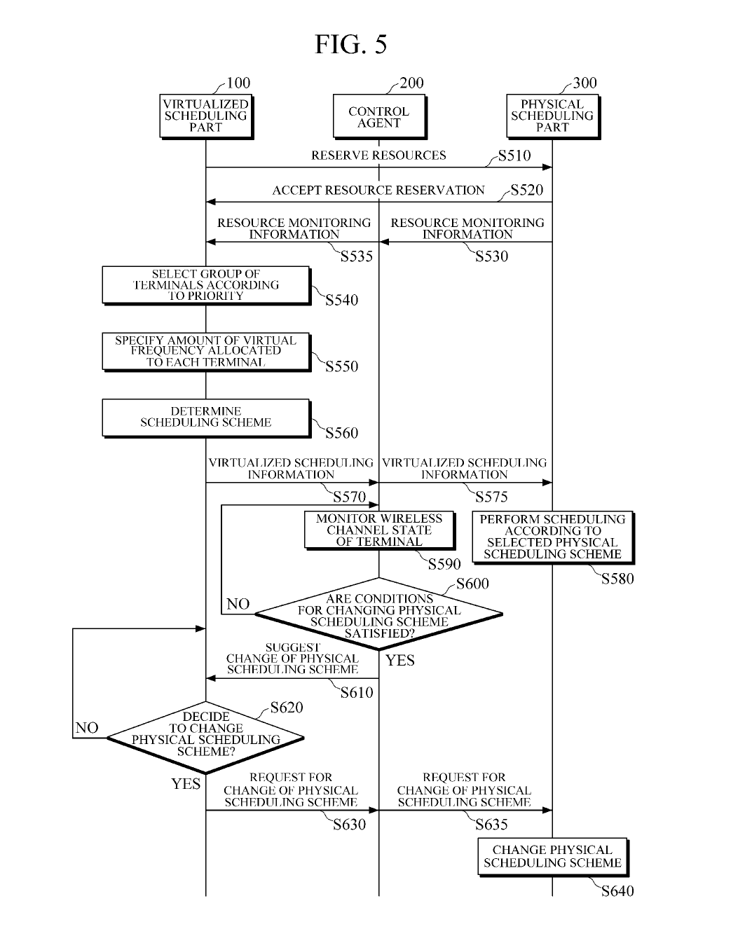

FIG. 5 is a signal flowchart for explaining a method for allocating base station resources based on virtualization according to an exemplary embodiment.

Referring to FIG. 5, a virtual scheduler included in a virtual scheduling part 100 and operated by an MVNO reserves the time for use resources and an amount of resources to use per unit time from MNOs that operate a physical scheduling part 300, as depicted in S510. If the MNO takes a reservation for resources, as depicted in S520, it indicates that the MNO has enough resources to meet the reservation, and hence the MNO should ensure the reserved amount of resources to be allocated to the MVNO.

The physical scheduling part 300 transmits resource monitoring information that contains wireless channel information of each user terminal to the virtual scheduling part 100 via a control agent 200, as depicted in S530 and S535. The wireless channel information may include at least one of the following information: currently reserved wireless resources, wireless resources currently used on average, and a state of packet queue of each terminal.

The virtual scheduling part 100 performs virtual scheduling based on the wireless channel information, for which the virtual scheduler selects one or more terminals according to priorities based on service characteristics, as depicted in S540, and generates scheduling virtualization information that specifies an amount of virtual frequency allocated to each of the selected terminal, as depicted in S550. Thereafter, the virtual scheduling part 100 transmits the scheduling virtualization information to the physical scheduling part 300 through the control agent 200, as depicted in S570 and S575, along with a scheduling scheme chosen as depicted in S560. In specific, the virtual scheduling part 100 selects either a channel scheduling scheme or a QoS scheduling scheme, and requests scheduling to the physical scheduling part.

The physical scheduling part 300 is operated by the MNOs, and physically allocates resources according to the virtual scheduling result, in response to a resource allocation request from the virtual scheduling part 100, as depicted in S580. At this time, the physical scheduling part 300 performs physical scheduling according to the requested scheduling scheme, for which in response to a request for a channel scheduling scheme, the physical scheduling part 300 allocates the resources by changing positions of frequency domains suitable for the wireless channel environment of each terminal, according to the received scheduling virtualization information.

Alternatively, in response to a request for a QoS scheduling scheme, the physical scheduling part 300 allocates the resources by modifying the scheduling virtualization information in a physical space based on the wireless channel state. At this time, the physical scheduling part 300 may use one of QoS scheduling algorithms that may be differently applicable according to service characteristics provided in a virtual scheduling space. The QoS scheduling algorithms may include PF, M-LWDF and DMDS algorithms. Specifically, each of the MVNOs 110, 120, and 130 selects in advance one of the QoS scheduling algorithms, and then the physical scheduling part 300 is operated based on the previously selected QoS scheduling algorithm when the channel scheduler 310 is changed to the QoS scheduler 320.

The wireless channel state of each terminal is variable, and thus a condition that requires the consideration of the wireless channel state in terms of resource efficiency may arise. In order to change the physical scheduling scheme, the control agent 200 may suggest an efficient scheduler suitable for a current channel environment.

The control agent 200 monitors the wireless channel state of each terminal, as depicted in S590. When <Condition 1> and <Condition 2> are satisfied in the course of channel scheduling, as depicted in S600, the control agent 200 suggests the virtual scheduling part 100 change a physical scheduling scheme, as depicted in S610.

A decision on the change of the physical scheduling scheme is made by each of relevant MVNOs 110, 120, and 130 of the virtual scheduling part 100, as depicted in S620. If the decision is made to change the physical scheduling scheme, the virtual scheduling part 100 issues a request for changing a physical scheduling scheme to the physical scheduling part 300 via the control agent 200, as depicted in S630 and 635.

The physical scheduling part 300 changes the physical scheduling scheme in response to said request, as depicted in S640.

The operations in the flowchart are described herein in a time sequential manner, but they may be performed concurrently with each other, or the order in which the operations are performed may be changed.

According to the above exemplary embodiments, virtualization concept is introduced to a base station scheduling function, thereby providing service providers with a scheduling function desired by said service providers, as well as a scheduling function that takes into consideration a wireless channel environment.

Further, as a virtual scheduling function and a physical scheduling function are separated from each other, the complexity of a scheduler and an overhead required for transmitting wireless channel control information can be reduced.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for allocating base station resources based on virtualization, the apparatus comprising:
a virtual scheduling part configured to comprise virtual schedulers each of which is operated for each of mobile virtual network operators (MVNOs) and performs virtual scheduling based on characteristics of a mobile service provided by each of the MVNOs, and to request resource allocation according to a virtual scheduling result;
a physical scheduling part configured to comprise a channel scheduler and a quality of service (QoS) scheduler and allocate physical resources using either the channel scheduler or the QoS scheduler according to the virtual scheduling result, in response to the request for resource allocation from the virtual scheduler, wherein the channel scheduler allocates the resources by changing a position of a frequency domain suitable for a wireless channel environment of each terminal and the QoS scheduler allocates the resources by modifying the virtual scheduling result, based on a wireless channel state, in a physical space; and
a control agent configured to interface between the virtual scheduling part and the physical scheduling part.

2. The apparatus of claim 1, wherein:
the physical scheduling part comprises a resource monitoring part configured to generate wireless channel information of each user terminal and transmit the wireless channel information to the control agent, and
the virtual scheduling part performs virtual scheduling according to the wireless channel information transmitted through the control agent.

3. The apparatus of claim 2, wherein the wireless channel information comprises at least one of the following information: currently reserved wireless resources, wireless resources currently used on average, and a state of packet queue of each terminal.

4. The apparatus of claim 3, wherein the control agent comprises a monitoring application program interface (API) to relay information from the resource monitoring part to the virtual scheduling part, wherein the monitoring API creates an admission control list for terminals that do not meet the lowest MCS level and transmits the admission control list to the virtual scheduling part.

5. The apparatus of claim 4, wherein the monitoring API instructs the virtual scheduling part that it is required to increase or reduce an amount of reserved resources.

6. The apparatus of claim 1, wherein the virtual scheduler selects one or more terminals according to priorities based on service characteristics, and transmits scheduling virtualization information to the physical scheduling part through the control agent, wherein the scheduling information specifies an amount of virtual frequency allocated to each of the selected terminal.

7. The apparatus of claim 6, wherein the virtual scheduling part transmits the scheduling information to either the channel scheduler or the QoS scheduler through the control agent.

8. The apparatus of claim 7, wherein the control agent comprises a scheduler API to suggest either the channel scheduler or the QoS scheduler according to the service characteristics and a current channel environment.

9. The apparatus of claim 8, wherein the scheduler API calculates a bit number by changing an order of terminals in a group provided by each MVNO and an amount of resources allocated to each terminal such that a QoS scheduling scheme can be satisfied, and in a case where a number of terminals forcibly terminated exceeds a specific value and a result of subtracting a channel scheduling bit rate from a QoS scheduling bit rate exceeds another specific value, the scheduler API suggests change from the channel scheduler to the QoS scheduler.

10. The apparatus of claim 1, wherein the QoS scheduler is operated based on one of QoS scheduling algorithms that is previously selected by the MVNO, the QoS scheduling algorithms including proportional fair (PF), modified largest weighted delay first (M-LWDF) and distributed minimum-distortion scheduling (DMDS) algorithms.

11. A method for allocating base station resources based on virtualization, the method comprising:
virtually scheduling based on characteristics of a mobile service provided by each of mobile virtual network operators (MVNOs); and
physically allocating the resources by changing a position of a frequency domain suitable for a wireless channel environment of each terminal or physically allocating the resources by modifying a virtual scheduling result in a physical space by taking into consideration a wireless channel state of each terminal, according to a virtual scheduling result.

12. The method of claim 11, wherein the virtual scheduling comprises performing virtual scheduling according to wireless channel information of each user terminal.

13. The method of claim 12, wherein the wireless channel information comprises at least one of the following information: currently reserved wireless resources, wireless resources currently used on average, and a state of packet queue of each terminal.

14. The method of claim 12, wherein the virtual scheduling comprises selecting one or more terminals according to priorities based on service characteristics, and generating scheduling virtualization information that specifies an amount of virtual frequency allocated to each of the selected terminal.

15. The method of claim 11, wherein the physically allocating of the resources comprises performing either a channel scheduling scheme or a QoS scheduling scheme according to the scheduling virtualization information, wherein the channel scheduling scheme allocates the resources by changing a position of a frequency domain suitable for a wireless channel environment of each terminal and the QoS scheduling scheme allocates the resources by modifying the scheduling virtualization information in a physical space by taking into consideration a wireless channel state of each terminal.

16. The method of claim 15, wherein the virtual scheduling comprises receiving a choice made by a mobile service provider between the channel scheduling scheme and the QoS scheduling scheme.

17. The method of claim 16, further comprising:
suggesting either the channel scheduling scheme or the QoS scheduling scheme to the mobile service provider according to the service characteristics and a current channel environment.

18. The method of claim 17, wherein the suggesting of the scheduling scheme comprises calculating a bit number by changing an order of terminals in a group provided by each MVNO and an amount of resources allocated to each terminal such that the QoS scheduling scheme can be satisfied, and in a case where a number of terminals forcibly terminated exceeds a specific value and a result of subtracting a channel scheduling bit rate from a QoS scheduling bit rate exceeds another specific value, suggesting change from the channel scheduler to the QoS scheduler.

19. The method of claim 11, wherein in the physically allocating of the resources by modifying the virtual scheduling result in a physical space by taking into account a wireless channel state, the allocation is based on one of QoS scheduling algorithms that is previously selected by the MVNO, the QoS scheduling algorithms including proportional fair (PF), modified largest weighted delay first (M-LWDF) and distributed minimum-distortion scheduling (DMDS) algorithms.
